(19) United States
(12) Patent Application Publication
(10) Pub. No.: US 2002/0007261 A1
(43) Pub. Date: Jan. 17, 2002

(54) Circuit simulating apparatus performing simulation with unnecessary ciruit disconnected

(75) Inventors: Yoshihito Ochi, Hyogo (JP); Tetsuya Muta, Hyogo (JP); Yoshiki Nakamura, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha and Mitsubishi Electric System LSI Design Corporation

(21) Appl. No.: 09/764,137

(22) Filed: Jan. 19, 2001

(30) Foreign Application Priority Data
Jul. 17, 2000 (JP) 2000-215558

(51) Int. Cl. G06F 9/455

(52) U.S. Cl. 703/14

(57) ABSTRACT

A circuit simulating apparatus includes a netlist extracting unit extracting a netlist from circuit diagram data, an unnecessary circuit disconnecting unit forming a netlist with an unnecessary circuit disconnected, from the netlist extracted by the netlist extracting unit, based on an unnecessary circuit disconnecting terminal designated by an unnecessary circuit disconnecting terminal designating unit, and a circuit simulation unit performing a circuit simulation using a simulation input file formed by using the netlist with the unnecessary circuit disconnected. As the circuit simulation is performed using the simulation input file formed from the netlist with the unnecessary circuit disconnected, the time necessary for the circuit simulation can be reduced.

### BACKGROUND OF THE INVENTION

1. Field of the Invention

The present invention relates to a circuit simulating apparatus for analyzing whether LSI (Large Scale Integrated) circuits realize circuit functions in compliance with the design specification. More specifically, the present invention relates to a circuit simulating apparatus analyzing a circuitry including an unnecessary circuit of which analysis is unnecessary, the method therefore, and to a recording medium recording the program therefor.

2. Description of the Background Art

Circuit scale of LSIs comes to be larger and larger as the degree of integration and function of the LSIs increased. Further, the time necessary for developing LSIs becomes longer. A method of reducing the time period for development includes increasing a speed of operation of a circuit simulating apparatus verifying circuit operation in the stage of designing LSI.

FIG. 1 is a block diagram showing a schematic configuration of a conventional circuit simulating apparatus. The circuit simulating apparatus includes: a netlist extracting unit 102 extracting a netlist from a logic circuit diagram data 101; a netlist storing unit 103 storing the netlist extracted by netlist extracting unit 102; a model parameter storing unit 104 storing model parameters of logic gates and the like used in the logic circuit diagram; a simulation input file forming unit 106 forming an input file for simulation with reference to the netlist stored in netlist storing unit 103, model parameters stored in model parameter storing unit 104 and analysis condition 105; a simulation input file storing unit 107 storing the simulation input file; a circuit simulating unit 108 executing circuit simulation, using the simulation input file and a test pattern formed previously; and a simulation result storing unit 109 storing the result of simulation.

Netlist extracting unit 102 forms a netlist describing connection relation between various circuit components of the logic circuit, with reference to logic circuit diagram data 101 obtained by a circuit design in the step of logic circuit design. Simulation input file forming unit 106 refers to the netlist, extracts a model parameter representing electrical characteristic of each circuit component from model parameter storing unit 104, and forms a simulation input file that includes the netlist with the model parameter and the analysis condition 105 added. Circuit simulation unit 108 performs analysis in accordance with the simulation input file and the test pattern, and stores the result of analysis in the simulation result storing file 109. Analysis condition 105 includes power supply voltage, load capacitance of interconnections and so on.

FIG. 2 shows an example of a logic circuitry including an unnecessary circuit. Generally, the logic circuitry of an LSI includes an unnecessary circuit 119, which does not have any relation with the eventual function of the LSI, such as a delay adjustment circuit. As shown in FIG. 2, the unnecessary circuit 119 is connected to a main circuit 118 obtained through the circuit design, by means of circuit switching elements (such as high resistance elements) 120 and 121. Circuit switching elements 120 and 121 have unnecessary circuit switching terminals 122 to 125 added thereto, for disconnecting the connection between the main circuit 118 and the unnecessary circuit 119. Main circuit 118 includes an input terminal 126 for inputting a signal to main circuit 118, and an output terminal 127 for outputting a signal from main circuit 118.

The simulation input file formed by simulation input file forming unit 106 includes the information of unnecessary circuit 119 as well. Therefore, circuit simulation unit 108 simulates the whole logic circuitry, including the unnecessary circuit 119.

As described above, in the conventional logic simulating apparatus, simulation of the whole logic circuitry including the unnecessary circuit 119 is executed, and therefore the time necessary for circuit simulation becomes longer, resulting in longer time period for developing LSIs.

### SUMMARY OF THE INVENTION

An object of the present invention is to provide a circuit simulating apparatus that reduces time of analysis, by reducing the number of circuit components as the object of analysis, to provide the method therefor and to provide a recording medium recording the program therefor.

Another object of the present invention is to provide a circuit simulating apparatus capable of efficiently designating a circuit component of which analysis is unnecessary, to provide the method therefor and to provide a recording medium recording the program therefor.

According to an aspect, the present invention provides a circuit simulating apparatus analyzing a circuitry having a main circuit and an unnecessary circuit connected by means of a circuit switching element, including a netlist extracting unit extracting a netlist from a circuit diagram data, a designating unit for designating an element between the main circuit and the unnecessary circuit, an unnecessary circuit disconnecting unit forming a netlist having the unnecessary circuit disconnected, from the netlist extracted by the netlist extracting unit, based on the element designated by the designating unit, a simulation input file forming unit forming a simulation input file with reference to the netlist formed by the unnecessary circuit disconnecting unit, model parameters and analysis condition, and a circuit simulating unit executing a circuit simulation using the simulation input file formed by the simulation input file forming unit.

As the circuit simulating unit executes the circuit simulation using the simulation input file formed from the netlist with the unnecessary circuit disconnected, simulation of the unnecessary circuit is omitted, and the time necessary for circuit simulation can be reduced.

According to another aspect, the present invention provides a method of circuit simulation analyzing a circuitry having a main circuit and an unnecessary circuit connected by means of a circuit switching element, including the steps of: extracting a netlist from circuit diagram data; designating an element between the main circuit and the unnecessary circuit; forming a netlist with the unnecessary circuit disconnected, from the extracted netlist, based on the designated element; forming a simulation input file with reference to the formed netlist, model parameters and analysis conditions; and performing circuit simulation using the thus formed simulation input file.

As the circuit simulation is performed using the simulation input file formed from the netlist with the unnecessary circuit disconnected, simulation of the unnecessary circuit can be omitted, and the time necessary for circuit simulation can be reduced.

According to another aspect, the present invention provides a computer readable recording medium that records a program to be executed by a computer of a method of circuit simulation analyzing a circuitry having a main circuit and an unnecessary circuit connected by means of a circuit switching element, wherein the method of circuit simulation includes the steps of: extracting a netlist from circuit diagram data; designating an element between the main circuit and the unnecessary circuit; forming a netlist with the unnecessary circuit disconnected, from the extracted netlist, based on the designated element; forming a simulation input file with reference to the formed netlist, model parameters and analysis condition; and performing circuit simulation using the thus formed simulation input file.

As the circuit simulation is performed using the simulation input file formed from the netlist with the unnecessary circuit disconnected, simulation of the unnecessary circuit can be omitted, and the time necessary for circuit simulation can be reduced.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a block diagram representing a functional configuration of a conventional circuit simulating apparatus.

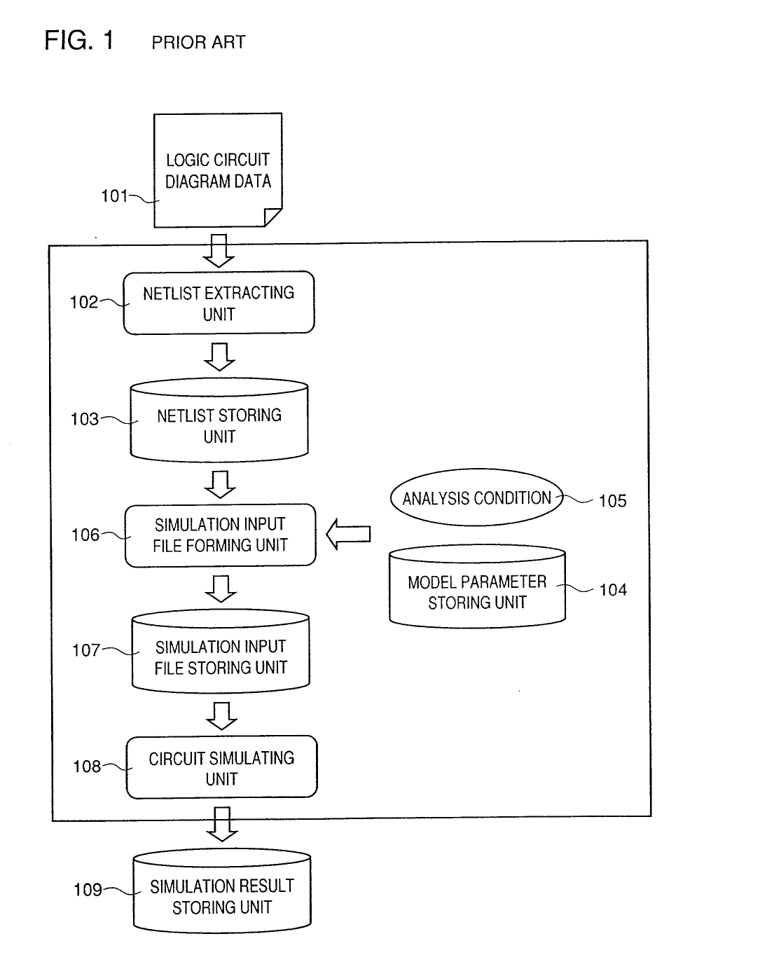

FIG. 2 is an illustration of a circuit switching element processed by the conventional circuit simulating apparatus.

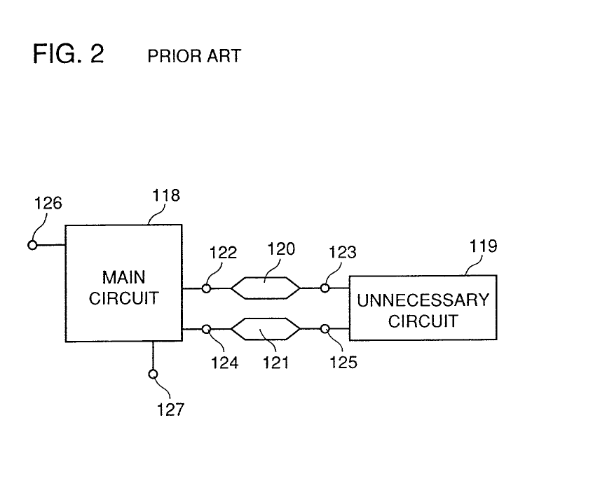

FIG. 3 is a block diagram representing a schematic configuration of a circuit simulating apparatus in accordance with an embodiment of the present invention.

FIG. 4 is a block diagram representing a functional configuration of the circuit simulating apparatus in accordance with the first embodiment of the present invention.

FIG. 5 is an illustration of a circuit switching element processed by the circuit simulating apparatus in accordance with the embodiment of the present invention.

FIG. 6 is a flow chart representing the process steps taken by the circuit simulating apparatus in accordance with the first embodiment of the present invention.

FIG. 7 is a block diagram representing a functional configuration of a circuit simulating apparatus in accordance with the second embodiment of the present invention.

FIG. 8 is a flow chart representing the process steps taken by the circuit simulating apparatus in accordance with the second embodiment of the present invention.

FIG. 9 is a block diagram representing a functional configuration of the circuit simulating apparatus in accordance with the third embodiment of the present invention.

FIG. 10 is a flow chart representing the process steps taken by the circuit simulating apparatus in accordance with the third embodiment of the present invention.

### DESCRIPTION OF THE PREFERRED EMBODIMENTS

First Embodiment

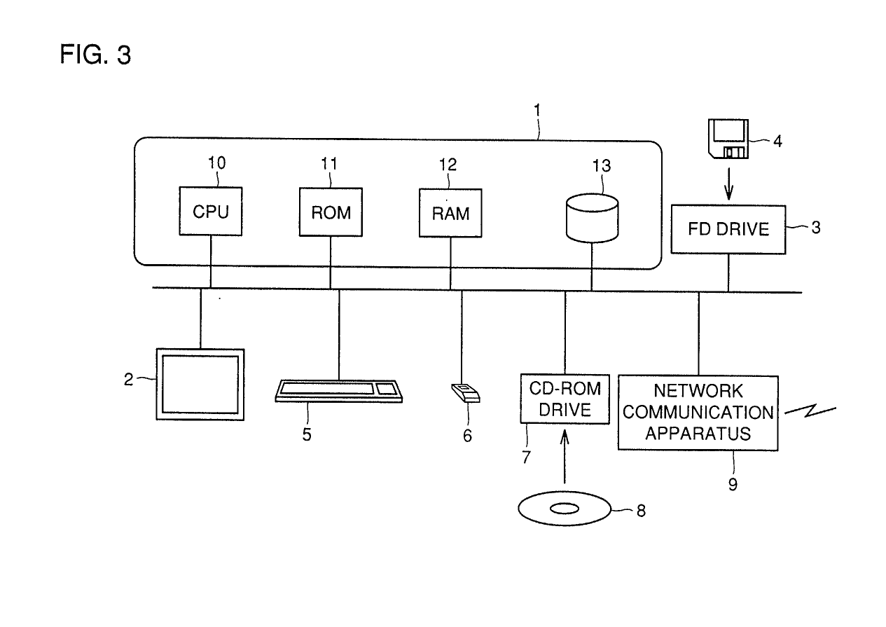

FIG. 3 shows a schematic configuration of the circuit simulating apparatus in accordance with an embodiment of the present invention. The circuit simulating apparatus includes a computer body 1, a graphic display apparatus 2, an FD drive 3 to which an FD (Floppy Disk) 4 is loaded, a keyboard, a mouse 6, a CD-ROM drive 7 to which a CD-ROM (Compact Disc-Read Only Memory) 8 is loaded, and a network communication apparatus 9. A circuit simulation program is supplied by a storage medium such as FD4 or CD-ROM 8. The circuit simulation program is executed by computer body 1, whereby the circuit simulation takes place. Alternatively, the circuit simulation program may be supplied to computer body 1 from another computer through the communication circuit.

Computer body 1 includes a CPU (Central Processing Unit) 10, an ROM (Read Only Memory) 11, an RAM (Random Access Memory) 12 and a hard disk 13. CPU 10 inputs/outputs data to and from graphic display apparatus 2, magnetic tape drive 3, keyboard 5, mouse 6, CD-ROM drive 7, network communicating apparatus 9, ROM 11, RAM 12 or hard disk 13, and performs processing. The circuit simulation program recorded on FD4 or CD-ROM 8 is once stored in hard disk 13, by the CPU 10, through FD drive 3 or CD-ROM drive 7. CPU 10 appropriately loads the circuit simulation program from hard disk 13 to RAM 12, whereby the circuit simulation is performed.

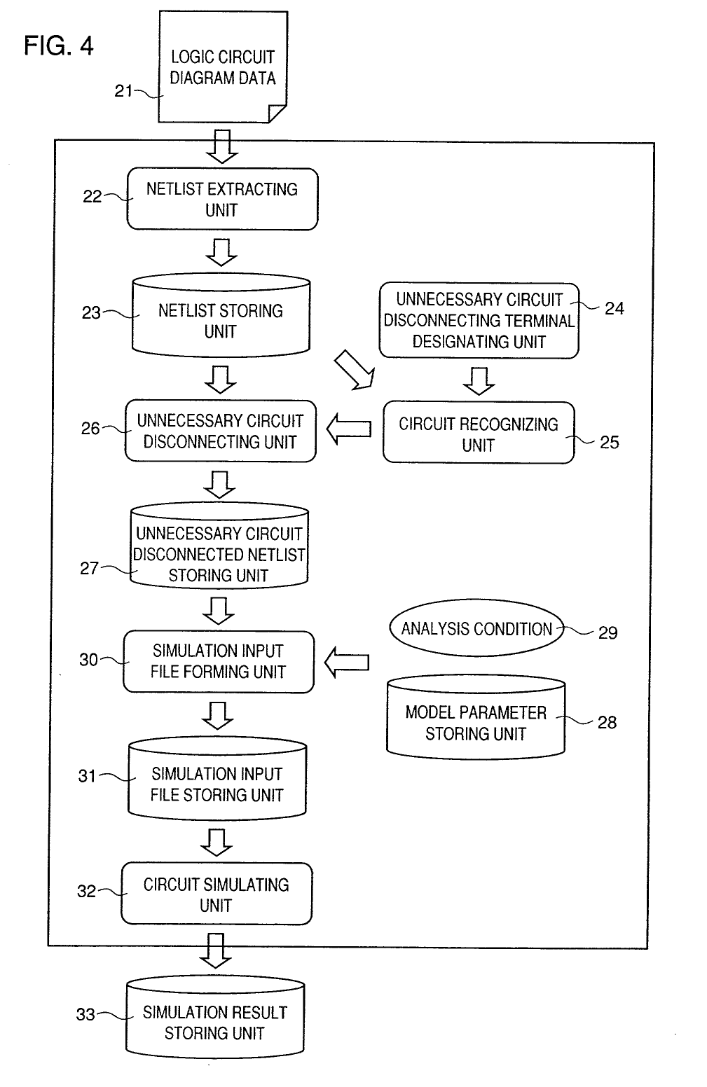

FIG. 4 is a block diagram representing a functional configuration of the circuit simulating apparatus in accordance with the embodiment of the present invention. The circuit simulating apparatus includes: a netlist extracting unit 22 extracting a netlist from logic circuit diagram data 21; a netlist storing unit 23 storing the netlist extracted by netlist extracting unit 22; an unnecessary circuit disconnecting terminal designating unit 24 designating a disconnecting terminal for the unnecessary circuit; a circuit recognizing unit 25 determining whether a logic circuit is a main circuit or an unnecessary circuit; an unnecessary circuit disconnecting unit 26 forming a netlist after the unnecessary circuit is disconnected from the main circuit; unnecessary circuit disconnected netlist storing unit 27 storing the netlist with the unnecessary circuit disconnected; a model parameter storing unit 28 storing model parameters of logic gates and the like used in the logic circuit diagram; a simulation input file forming unit 30 forming a simulation input file, with reference to the unnecessary circuit disconnected netlist stored in the unnecessary circuit disconnected netlist storing unit 27, the model parameters stored in model parameter storing unit 28 and analysis condition 29; a simulation input file storing unit 31 storing the simulation input file; a circuit simulating unit 32 executing circuit simulation, using the simulation input file and a test pattern formed in advance; and a simulation result storing unit 33 storing the result of simulation.

Netlist extracting unit 22 refers to the logic circuit diagram data 21 obtained by the circuit design in the step of logic circuit design, forms a netlist describing connection relation between various circuit components of the logic circuit, and stores the netlist in netlist storing unit 23.

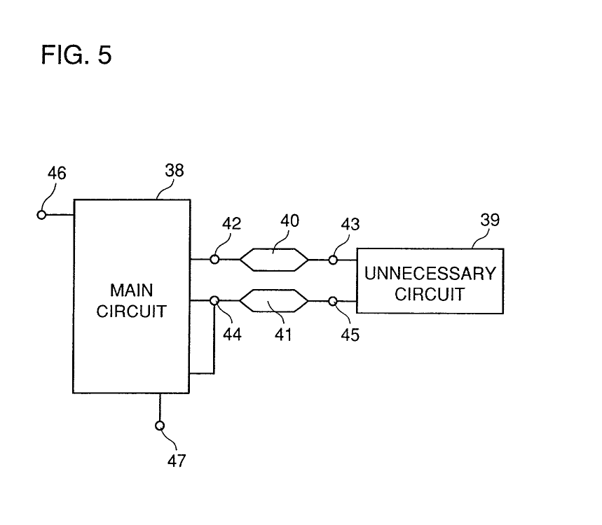

Unnecessary circuit disconnecting terminal designating unit 24 designates an unnecessary circuit disconnecting terminal (node number or the like) of the unnecessary circuit which is to be disconnected from the main circuit. For example, unnecessary circuit disconnecting terminals 42 to 45 are designated, for disconnecting the connection between the main circuit 38 and the unnecessary circuit 39 shown in FIG. 5.

The circuit recognizing unit 25 refers to the netlist stored in netlist storing unit 23, searches the input terminal 46 or output terminal 47 of main circuit 38 and, when the unnecessary circuit detecting terminals 42 to 45 designated by unnecessary circuit disconnecting terminal designating unit 24 are detected, determines the circuit on the search path side of unnecessary circuit disconnecting terminals 42 to 45 as the main circuit 38 and the circuit on the opposite side as the unnecessary circuit 39, and provides the information (hereinafter referred to as circuit recognition information) to unnecessary circuit disconnecting unit 26.

Upon reception of the circuit recognition information from circuit recognizing unit 25, unnecessary circuit disconnecting unit 26 adds a connection description for connecting the unnecessary circuit disconnecting terminals 43 and 45 on the side of the unnecessary circuit 39 of the netlist with the power supply or the GND (ground), and converts the element description for connection with the unnecessary circuit disconnecting terminals 43 and 45 on the side of the unnecessary circuit 39 to comment description, or deletes the element description, whereby an unnecessary circuit disconnected netlist with the unnecessary circuit 39 disconnected is formed, which netlist is stored in unnecessary circuit disconnected netlist storing unit 27.

Simulation input file forming unit 30 extracts the unnecessary circuit disconnected netlist stored in unnecessary circuit disconnected netlist storing unit 27, extracts model parameters representing electric characteristics of various circuit components from model parameter storing unit 28, and forms a simulation input file having the model parameter and analysis condition 29 added. Circuit simulation unit 32 performs analysis in accordance with the simulation input file and the test pattern, and stores the result of analysis in simulation result storing file 33.

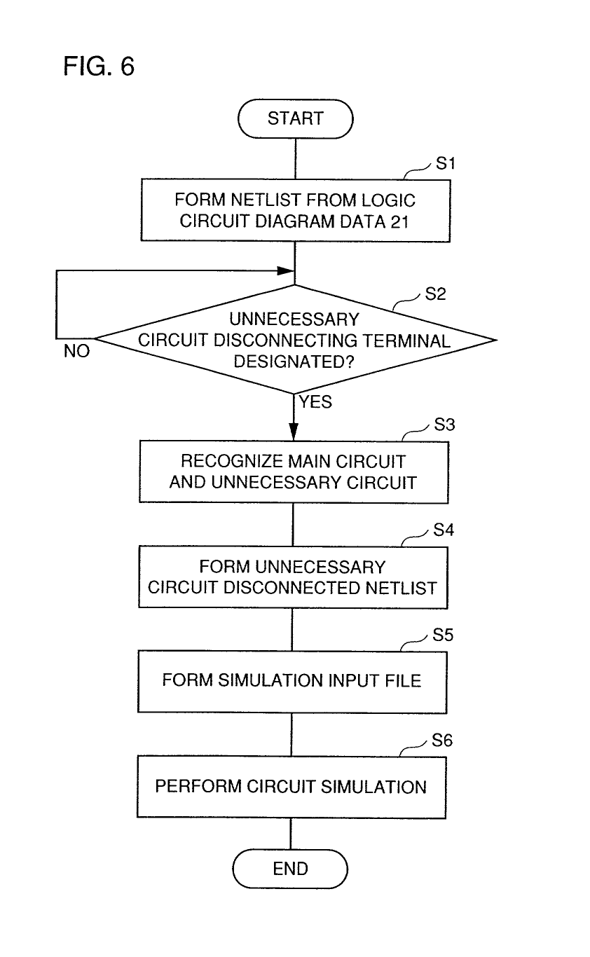

FIG. 6 is a flow chart representing the process steps taken by the circuit simulating apparatus in accordance with an embodiment of the present invention. Netlist extracting unit 22 receives as inputs the logic circuit diagram data 21, forms a netlist, and stores the netlist in netlist storing unit 23 (Si). Unnecessary circuit disconnecting terminal designating unit 24 determines whether an unnecessary circuit disconnecting terminal is designated by a user or not (S2). If the unnecessary circuit disconnecting terminal is not designated by the user (S2, No), the process of step S2 is repeated. When the unnecessary circuit disconnecting terminal is designated by the user (S2, Yes), the information thereof is output to circuit recognizing unit 25.

Thereafter, as the unnecessary circuit disconnecting terminal designated by the user is input, the circuit recognizing unit 25 searches the unnecessary circuit disconnecting terminal by the method described above. Then, the circuit recognizing unit 25 determines the circuit on the side of the search path as the main circuit 38 and the circuit on the opposite side as the unnecessary circuit 39, and outputs the circuit recognition information to unnecessary circuit disconnecting unit 26 (S3).

Thereafter, as the circuit recognition information is input, the unnecessary circuit disconnecting unit 26 forms the unnecessary circuit disconnected netlist, in which the main circuit and the unnecessary circuit are disconnected, by the method described above, and stores the netlist in the unnecessary circuit disconnected netlist storing unit 27 (S4).

The simulation input file forming unit 30 forms a simulation input file, which includes the unnecessary circuit disconnected netlist stored in the unnecessary circuit disconnected netlist storing unit 27 with the model parameter extracted from model parameter storing unit 28 and analysis condition 29 added, and stores the simulation input file in simulation input file storing unit 31 (S5).

Finally, the circuit simulation unit 32 performs analysis in accordance with the simulation input file and the test pattern, stores the result of analysis in the simulation result storing file 33 (S6) and terminates the process.

As described above, in the circuit simulating apparatus in accordance with the present invention, the circuit simulation is performed with the circuit which becomes eventually unnecessary in view of the circuit function of the LSI disconnected on the netlist, the circuit components as the object of analysis can be reduced, and the time for analysis can significantly be reduced.

Second Embodiment

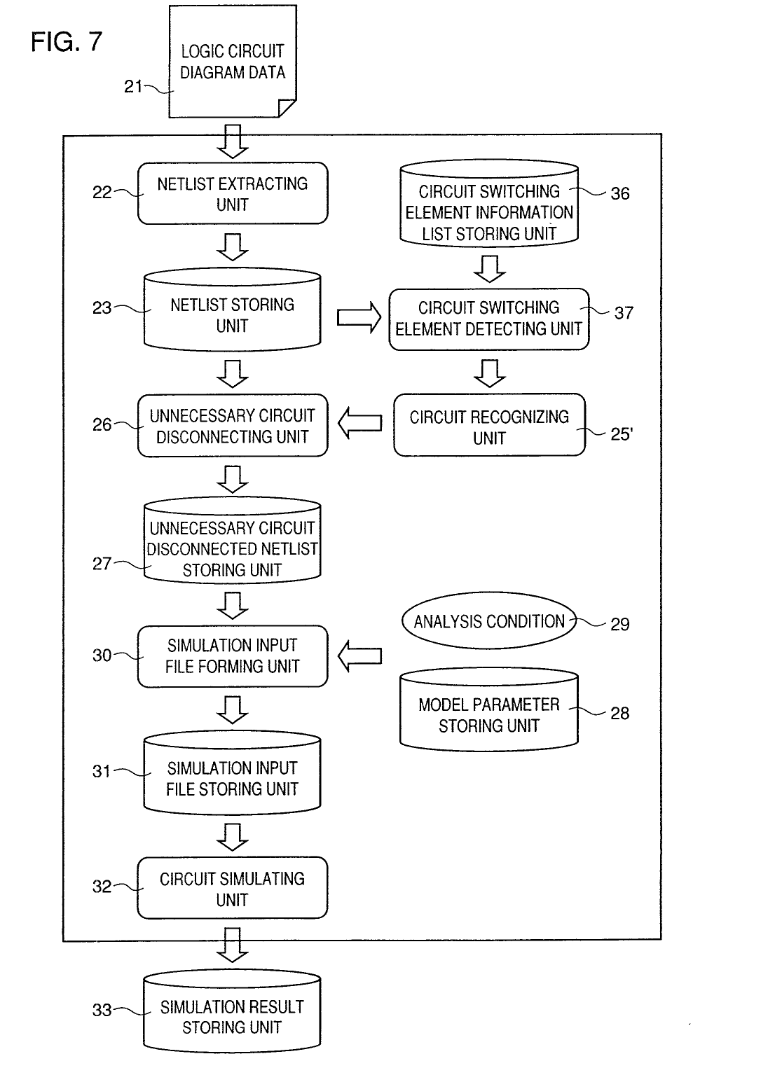

FIG. 7 is a block diagram showing a schematic configuration of the circuit simulating apparatus in accordance with a second embodiment of the present invention. The configuration of the circuit simulation apparatus in accordance with the present embodiment differs from the configuration of the circuit simulation apparatus in accordance with the first embodiment shown in FIG. 4 in that the unnecessary circuit disconnecting terminal designating unit 24 is replaced by a circuit switching element information list storing unit 36 and a circuit switching element detecting unit 37, and that the circuit recognizing unit has a different function. Therefore, descriptions of the corresponding configurations and the functions will not be repeated. In the following, the circuit recognizing unit will be denoted by the reference numeral 25′.

The circuit switching element information list storing unit 36 stores circuit switching element information list, in which information (element name and the like) specifying the circuit switching element connecting the main circuit with the unnecessary circuit defined in advance is stored. For example, a list defining the information specifying the circuit switching elements 40 and 41 shown in FIG. 5 is stored.

Circuit switching element detecting unit 37 refers to the circuit switching element information list stored in circuit switching element information list storing unit 36, searches from input terminal 46 or output terminal 47 of main circuit 38 and, upon detection of circuit switching element 40, identifies the unnecessary circuit disconnecting terminals 42 and 44 on the side of the search path of the circuit switching element 40 and the unnecessary circuit disconnecting terminals 43 and 45 on the other side.

Circuit recognizing unit 25′ recognizes the circuit connected to unnecessary circuit disconnecting terminals 42 and 44 on the side of the search path as the main circuit 38, and recognizes the circuit connected to the unnecessary circuit disconnecting terminals 43 and 45 on the other side as the unnecessary circuit 39. Then circuit recognizing unit 25′ provides the circuit recognition information to unnecessary circuit disconnecting unit 26.

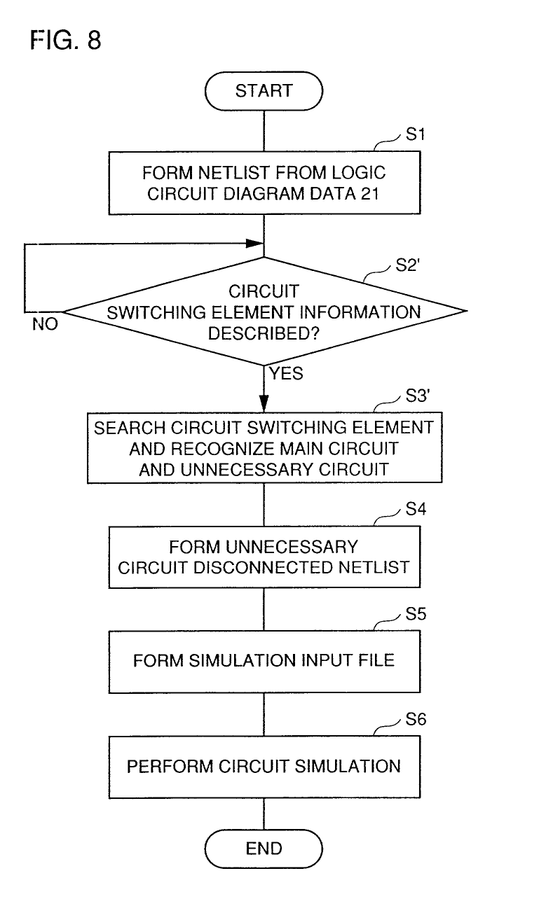

FIG. 8 is a flow chart representing the process steps of the circuit simulating apparatus in accordance with the present embodiment. The flow differs from the process steps of the circuit simulating apparatus in accordance with the first embodiment shown in FIG. 6 only in the processes of steps S2 and S3. Therefore, detailed description of the overlapping process steps will not be repeated. The processes in steps S2 and S3 of the present embodiment will be denoted by steps S2′ and S3′.

In step S2′, the circuit switching element detecting unit 37 determines whether the circuit switching element information is described in the circuit switching element information list or not. If the circuit switching element information is not described (S2′, No), the process of step S2′ is repeated.

When the circuit switching element information is described (S2′, Yes), circuit switching element detecting unit 37 identifies the unnecessary circuit disconnecting terminal on the side of the search path of the circuit switching element and the unnecessary circuit switching terminal on the other side, and provides the information to circuit recognizing unit 25′. The circuit recognizing unit 25′ recognizes the circuit connected to the unnecessary circuit disconnecting terminal on the side of the search path as the main circuit, recognizes the circuit on the other side as the unnecessary circuit, and provides the circuit recognition information to unnecessary circuit disconnecting unit 26 (S3′).

As described above, in the circuit simulating apparatus in accordance with the present embodiment, circuit simulation is performed with the circuit which becomes eventually unnecessary in view of the circuit function of the LSI disconnected on the netlist, and therefore the circuit components as the object of analysis can be reduced, and the time for analysis can significantly be reduced. Further, the information of the circuit switching element is defined in advance in the circuit switching element information list, and the circuit switching element is searched based on the information. Therefore, erroneous designation of the unnecessary circuit disconnecting terminal or failure to designate the unnecessary circuit disconnecting terminal, that are possible in the circuit simulation apparatus in accordance with the first embodiment, can be avoided, and the unnecessary circuit can be omitted efficiently and accurately.

Third Embodiment

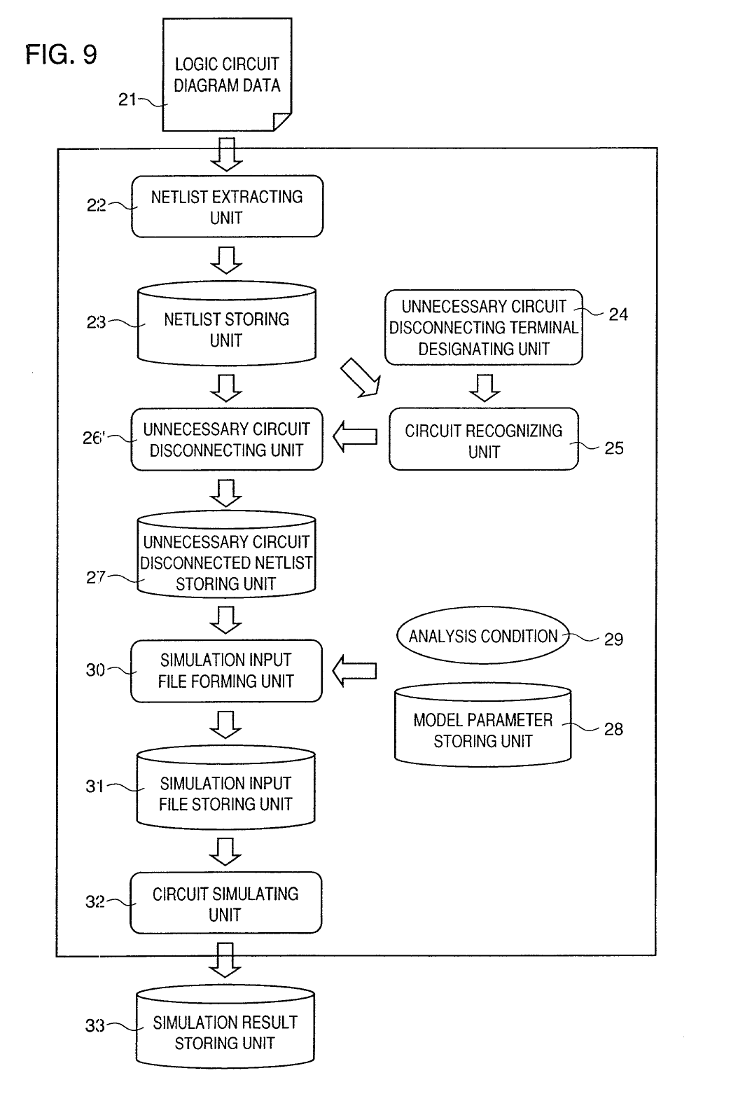

Referring to FIG. 9, the configuration of the circuit simulating apparatus in accordance with the third embodiment of the present invention differs from the configuration of the circuit simulating apparatus in accordance with the first embodiment shown in FIG. 4 only in the function of the unnecessary circuit disconnecting unit. Therefore, detailed description of the overlapping configurations and functions will not be repeated. The unnecessary circuit disconnecting unit in the present embodiment will be denoted by the reference numeral 26′. Further, it is possible to replace the unnecessary circuit disconnecting unit 26 in the circuit simulating apparatus in accordance with the second embodiment shown in FIG. 7 with the unnecessary circuit disconnecting unit 26′.

When the unnecessary circuit is to be disconnected upon input of the circuit recognition information from circuit recognizing unit 25 or 25′, the unnecessary circuit disconnecting unit 26 disconnects the unnecessary circuit disconnecting terminal on the side of the main circuit from the circuit switching element, rather than connecting the unnecessary circuit disconnecting terminal of the unnecessary circuit side to the power supply or to the GND, if the unnecessary circuit disconnecting terminal on the side of the search path (on the side of the main circuit) is connected to a plurality of main circuit elements. For example, the unnecessary circuit switching terminal 44 is connected to the plurality of elements of main circuit 38 as shown in FIG. 5, and therefore, by simply disconnecting the circuit switching element 41 from unnecessary circuit disconnecting terminal 44, a functional circuit can be formed. For such an unnecessary circuit disconnecting terminal 44, unnecessary circuit disconnecting unit 26′ changes the element description to a comment description, or deletes the element description, so that the unnecessary circuit disconnecting terminal is disconnected from the circuit switching element 41.

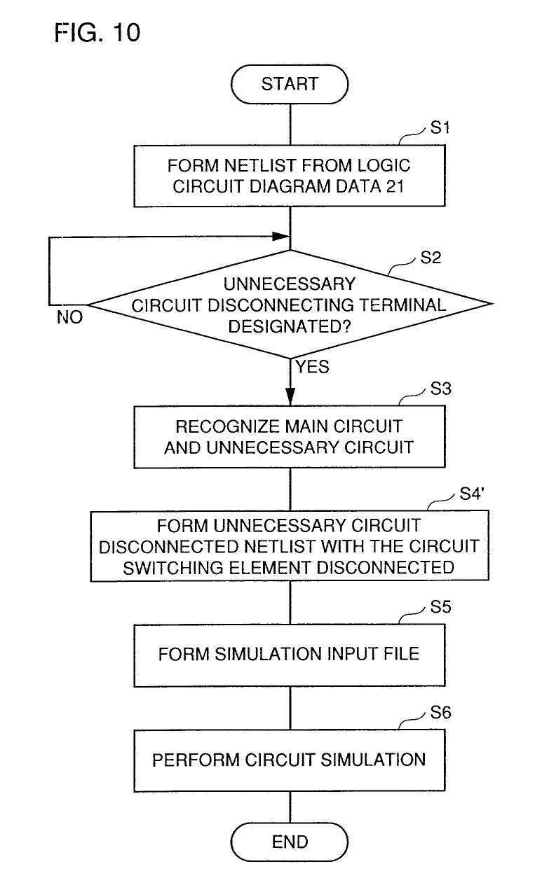

FIG. 10 is a flow chart representing the process steps of the circuit simulating apparatus in accordance with the present embodiment. The difference from the process steps in accordance with the first embodiment shown in FIG. 6 is only the process of step S4. Therefore, detailed description of the overlapping processes will not be repeated. Here, the process of step S4 in the present embodiment will be denoted as step S4′.

In step S4′, when the unnecessary circuit disconnecting terminal on the side of the search path is not connected to a plurality of main circuit elements, unnecessary circuit disconnecting unit 26 changes the element description of the unnecessary circuit disconnecting terminal of the unnecessary circuit side to a comment description, or deletes the element description. When the unnecessary circuit disconnecting terminal on the side of the search path is connected to a plurality of main circuit elements, the unnecessary circuit disconnecting unit 26′ changes the element description of the unnecessary circuit disconnecting terminal to a comment description, or deletes the element description, so that the circuit switching element is disconnected.

As described above, in the circuit simulating apparatus in accordance with the present embodiment, the circuit switching element is disconnected from the unnecessary circuit disconnecting terminal on the side of the main circuit on the netlist, and therefore, the time necessary for analysis can further be reduced, in addition to the effects attained by the first and second embodiments.

Although the present invention has been described and illustrated in detail,it is clearly understood that the same is by way of illustration and example only and it is not to be taken by way of limitation, the spirit and scope of the present invention being limited only by the terms of the appended claims.

What is claimed is:

1. A circuit simulating apparatus analyzing a circuitry having a main circuit and an unnecessary circuit connected by a circuit switching element, comprising:
a netlist extracting unit extracting a netlist from a circuit diagram data;
a designating unit designating an element between the main circuit and the unnecessary circuit;
an unnecessary circuit disconnecting unit forming a netlist with the unnecessary circuit disconnected, from the netlist extracted by said netlist extracting unit, based on the element designated by said designating unit;
a simulation input file forming unit forming a simulation input file, with reference to the netlist formed by said unnecessary circuit disconnecting unit, a model parameter and an analysis condition; and
a circuit simulating unit performing a circuit simulation using the simulation input file formed by said simulation input file forming unit.

2. The circuit simulating apparatus according to claim 1, wherein
said designating unit includes an unnecessary circuit disconnecting terminal designating unit designating an unnecessary circuit disconnecting terminal; and
said unnecessary circuit disconnecting unit forms the netlist with the unnecessary circuit disconnected from the netlist extracted by said netlist extracting unit, based on the unnecessary circuit disconnecting terminal designated by said unnecessary circuit disconnecting terminal designating unit.

3. The circuit simulating apparatus according to claim 2, further comprising
a circuit recognizing unit recognizing whether the unnecessary circuit disconnecting terminal designated by said unnecessary circuit disconnecting terminal designating unit is on the main circuit side or the unnecessary circuit side; wherein
said unnecessary circuit disconnecting unit adds a description for connecting the unnecessary circuit disconnecting terminal recognized to be on the side of the unnecessary circuit by said circuit recognizing unit to a power supply or to the ground, and adds a description for disconnecting connection with said unnecessary circuit, on the netlist extracted by said netlist extracting unit.

4. The circuit simulating apparatus according to claim 2, further comprising
a circuit recognizing unit for recognizing whether the unnecessary circuit disconnecting terminal designated by said unnecessary circuit disconnecting terminal designating unit is on the main circuit side or on the unnecessary circuit side; wherein
said unnecessary circuit disconnecting unit adds a description for disconnecting connection between the unnecessary circuit disconnecting terminal on the main circuit side with the circuit switching element on the netlist extracted by said netlist extracting unit, when the unnecessary circuit disconnecting terminal recognized to be on the side of the main circuit by said circuit recognizing unit is connected to a plurality of elements of the main circuit.

5. The circuit simulating apparatus according to claim 1, wherein
said designating unit includes a circuit switching element specifying unit specifying a circuit switching element; and
said unnecessary circuit disconnecting unit forms a netlist with the unnecessary circuit disconnected from the netlist extracted by said netlist extracting unit, based on the circuit switching element specified by said circuit switching element specifying unit.

6. The circuit simulating apparatus according to claim 5, further comprising
a circuit recognizing unit recognizing whether the unnecessary circuit disconnecting terminal connected to the circuit switching element specified by said circuit switching element specifying unit is on the main circuit side or the unnecessary circuit side; wherein
said unnecessary circuit disconnecting unit adds a description for connecting the unnecessary circuit switching terminal recognized to be on the unnecessary circuit side by said circuit recognizing unit to a power supply or the ground, and adds a description for disconnecting connection with said unnecessary circuit, on the netlist extracted by said netlist extracting unit.

7. The circuit simulating apparatus according to claim 5, further comprising
a circuit recognizing unit for recognizing whether the unnecessary circuit disconnecting terminal designated by said unnecessary circuit disconnecting terminal designating unit is on the main circuit side or on the unnecessary circuit side; wherein
said unnecessary circuit disconnecting unit adds a description for disconnecting connection between the unnecessary circuit disconnecting terminal on the main circuit side with the circuit switching element on the netlist extracted by said extracting unit, when the unnecessary circuit disconnecting terminal recognized to be on the side of the main circuit by said circuit recognizing unit is connected to a plurality of elements of the main circuit.

8. A method of circuit simulation, analyzing a circuitry having a main circuit and an unnecessary circuit connected by a circuit switching element, comprising the steps of:
extracting a netlist from circuit diagram data:
designating an element between the main circuit and the unnecessary circuit;
forming a netlist with the unnecessary circuit disconnected from said extracted netlist, based on said designated element;
forming a simulation input file with reference to said formed netlist, a model parameter and an analysis condition; and
performing a circuit simulation using said formed simulation input file.

9. The method of circuit simulation according to claim 8, wherein
said step of designating an element between said main circuit and the unnecessary circuit includes the step of designating an unnecessary circuit disconnecting terminal; and
said step of forming a netlist with the unnecessary circuit disconnected from said extracted netlist includes the step of forming a netlist with the unnecessary circuit disconnected from said extracted netlist, based on said designated unnecessary circuit disconnecting terminal.

10. The method of circuit simulation according to claim 9 further comprising the step of
recognizing whether said designated unnecessary circuit disconnecting terminal is on the main circuit side or on the unnecessary circuit side; wherein
said step of forming a netlist with the unnecessary circuit disconnected from said extracted netlist includes the step of adding a description for connecting the unnecessary circuit disconnecting terminal recognized to be on the unnecessary circuit side to a power supply or to the ground, and adding a description for disconnecting connection with said unnecessary circuit, on said extracted netlist.

11. The method of circuit simulation according to claim 9, further comprising the step of
recognizing whether said designated unnecessary circuit disconnecting terminal is on the main circuit side or on the unnecessary circuit side; wherein
said step of forming a netlist with the unnecessary circuit disconnected from said extracted netlist includes the step of adding a description for disconnecting connection of the unnecessary circuit disconnecting terminal on the main circuit side and the circuit switching element, on said extracted netlist, when the unnecessary circuit disconnecting terminal recognized to be on the main circuit side is connected to a plurality of elements of the main circuit.

12. The method of circuit simulation according to claim 8, wherein
said step of designating an element between said main circuit and the unnecessary circuit includes the step of specifying a circuit switching element; and
said step of forming a netlist with the unnecessary circuit disconnected from said extracted netlist includes the step of forming a netlist with the unnecessary circuit disconnected from said extracted netlist, based on said specified circuit switching element.

13. The method of circuit simulation according to claim 12, further comprising the step of
recognizing whether the unnecessary circuit disconnecting terminal connected to said specified circuit switching element is on the main circuit side or on the unnecessary circuit side; wherein
said step of forming a netlist with the unnecessary circuit disconnected from said extracted netlist includes the step of adding a description for connecting the unnecessary circuit disconnecting terminal recognized to be on the unnecessary circuit side to a power supply or to the ground, and adding a description for disconnecting connection with said unnecessary circuit, on said extracted netlist.

14. The method of circuit simulation according to claim 12, further comprising the step of
recognizing whether said the unnecessary circuit disconnecting terminal connected to said specified circuit switching element is on the main circuit side or on the unnecessary circuit side; wherein said step of forming a netlist with the unnecessary circuit disconnected from said extracted netlist includes the step of adding a description for disconnecting connection between the unnecessary circuit disconnecting terminal on the main circuit side and circuit switching element, on said extracted netlist, when the unnecessary circuit disconnecting terminal recognized to be on the main circuit side is connected to a plurality of elements of the main circuit.

15. A computer readable recording medium recording a program to have a computer execute a method of circuit simulation analyzing a circuitry having a main circuit and an unnecessary circuit connected by a circuit switching element, wherein
said method of circuit simulation including the steps of:
extracting a netlist from circuit diagram data;
designating an element between the main circuit and the unnecessary circuit;
forming a netlist with the unnecessary circuit disconnected from said extracted netlist, based on said designated element;
forming a simulation input file with reference to said formed netlist, a model parameter and an analysis condition; and
performing a circuit simulation using said formed simulation input file.

16. The computer readable recording medium according to claim 15, wherein
said step of designating an element between said main circuit and the unnecessary circuit includes the step of designating an unnecessary circuit disconnecting terminal; and
said step of forming a netlist with the unnecessary circuit disconnected from said extracted netlist includes the step of forming a netlist with the unnecessary circuit disconnected from said extracted netlist, based on said designated unnecessary circuit disconnecting terminal.

17. The computer readable recording medium according to claim 16, wherein
said method of circuit simulation further includes the step of recognizing whether said designated unnecessary circuit disconnecting terminal is on the main circuit side or on the unnecessary circuit side; and
said step of forming a netlist with the unnecessary circuit disconnected from said extracted netlist includes the step of adding a description for connecting the unnecessary circuit disconnecting terminal recognized to be on the unnecessary circuit side to a power supply or to the ground, and adding a description for disconnecting connection with said unnecessary circuit, on said extracted netlist.

18. The computer readable recording medium according to claim 16, wherein
said method of circuit simulation further includes the step of recognizing whether said designated unnecessary circuit disconnecting terminal is on the main circuit side or on the unnecessary circuit side; and
said step of forming a netlist with the unnecessary circuit disconnected from said extracted netlist includes the step of adding a description for disconnecting connection of the unnecessary circuit disconnecting terminal on the main circuit side and the circuit switching element, on said extracted netlist, when the unnecessary circuit disconnecting terminal recognized to be on the main circuit side is connected to a plurality of elements of the main circuit.

19. The computer readable recording medium according to claim 15, wherein
said step of designating an element between said main circuit and the unnecessary circuit includes the step of specifying a circuit switching element; and
said step of forming a netlist with the unnecessary circuit disconnected from said extracted netlist includes the step of forming a netlist with the unnecessary circuit disconnected from said extracted netlist, based on said specified circuit switching element.

20. The computer readable recording medium according to claim 19, wherein
said method of circuit simulation further includes the step of recognizing whether the unnecessary circuit disconnecting terminal connected to said specified circuit switching element is on the main circuit side or on the unnecessary circuit side; and
said step of forming a netlist with the unnecessary circuit disconnected from said extracted netlist includes the step of adding a description for connecting the unnecessary circuit disconnecting terminal recognized to be on the unnecessary circuit side to a power supply or to the ground, and adding a description for disconnecting connection with said unnecessary circuit, on said extracted netlist.
